(19) United States
(12) Patent Application Publication
(10) Pub. No.: US 2004/0068973 A1
(43) Pub. Date: Apr. 15, 2004

(54) Burner and gas turbine engine

(76) Inventors: Tsutomu Wakabayashi, Osaka (JP); Koji Moriya, Osaka (JP)

Correspondence Address: Russell D Orkin, 700 Koppers Building, 436 Seventh Avenue, Pittsburgh, PA, 15219-1818, US

(21) Appl. No.: 10/471,117

(22) PCT Filed: Mar. 5, 2002
(86) PCT No.: PCT/JP02/02047

(30) Foreign Application Priority Data
Mar. 9, 2001 (JP) 2001-067062
Aug. 9, 2001 (JP) 2001-242212

(51) Int. Cl. F02C 9/28

(52) U.S. Cl. 60/39.281

(57) ABSTRACT

A burner apparatus relating to the present invention comprises a burner apparatus including a plurality of combustion channels (A1, A2) in which fuel (G) is supplied to air (A) communicated therein and the resultant fuel-air mixture is supplied to a combusting section (15) to be combusted therein. Each combustion channel (A1, A2) includes a supplying portion (5, 7) for supplying the fuel. A supplying passage (6) is provided between the respective combustion channels (A1, A2), the passage (6) being configured for receiving a portion of the fuel (G) supplied through the supplying portion (7) to the one fuel combustion channel (A2) and then supplying this to the supplying portion of the next-stage combustion channel (A1) only when the flow amount of the fuel from the supplying portion (7) is above a predetermined critical flow amount. Combustion load adjusting means (20) is provided for adjusting combustion load through adjustment of a total supply amount of the fuel (G) so that the flow amount of the fuel (G) from the supplying portion (7) may be contained within a range encompassing said predetermined critical flow amount.

### TECHNICAL FIELD

This invention relates to a burner apparatus including a plurality of combustion channels in which fuel is supplied to oxygen-containing gas communicated therein and the resultant fuel-air mixture is supplied to a combusting section to be combusted therein. The invention relates also to a gas turbine engine having the burner apparatus.

### BACKGROUND ART

The burner apparatus described above is used as a burner apparatus for a gas turbine engine used in a co-generation system or a burner apparatus used for an incinerator. With this burner apparatus, it is necessary not only to adjust the flow amounts of the fuel gas to be fed to a main combustion channel and a pilot combustion channel, in accordance with increase/decrease in the combustion load for assuring good combustion with maintaining appropriate equivalent ratio for the main combustion channel and the pilot combustion channel, but also to adjust the flow amounts of air (an example of the “oxygen-containing gas”) to be fed to the main combustion channel and the pilot combustion channel.

Conventionally, in order to make the adjustment of the flow amounts of the fuel gas to the main combustion channel and the pilot combustion channel, a flow-amount adjusting valve was provided in a fuel gas supply line to the main combustion channel and in a further fuel gas supply line to the pilot combustion channel, respectively, so as to make the adjustment of the flow amounts of the fuel gas to the main combustion channel and to the pilot combustion channel, independently of each other.

However, according to the prior art described above, as the adjustment of the supply amount of fuel gas to the main combustion channel and that to the pilot combustion channel in accordance with the combustion load are effected independently of each other, the adjustment operation was troublesome.

Further, in the case of the burner apparatus of the above type having a pilot combustion channel and a main combustion channel, the supply amounts of fuel gas respectively to the main combustion channel and to the pilot combustion channel are reduced in association with decrease in the combustion load relative to a rated combustion load. In association with such decrease in the supply amount, it is necessary to increase the supply amount to the pilot combustion channel to maintain stable pilot combustion.

Then, in recent years, there has been proposed a burner apparatus which allows easy adjustment of the supply amounts of the fuel gas to the main combustion channel and to the pilot combustion channel according to the combustion load or the like and which also allows the distribution ratio of the supply amount to the pilot combustion channel to be increased in accordance with reduction in the supply amount (Japanese Patent Application “Kokai” No.: 2000-002422).

This burner apparatus includes a pilot combustion channel for effecting the pilot combustion and a main combustion channel for effecting the main combustion and further includes supply openings for supplying the fuel to the main combustion channel and the pilot combustion channel, and a supply passage for receiving a portion of the fuel supplied from the supply opening of the pilot combustion channel and supplying it to the supply opening of the main combustion channel. That is to say, in the pilot combustion channel, between the supply opening and a receiving opening of the supply passage open to the pilot combustion channel, there is formed a slit-like open portion which is open to the pilot combustion channel. And, this open portion and the supply passage function as a fluid control construction for controlling movement of the fuel by means of the flow of air in the pilot combustion channel.

That is, with the burner apparatus, by means of the fluid control construction described above, in the pilot combustion channel, operation is possible with a large total supplying flow amount of the fuel to such an extent that most of the fuel which has been supplied from the supply opening to the open portion may be received from the receiving opening into the supply passage and then fed to the supply opening of the main combustion channel. On the other hand, when a low combustion load operation is to be effected with reduced combustion amount relative to the above-described high combustion load operation, with the above-described fluid control construction, in the pilot combustion channel, operation is possible with setting the total fuel supply amount to such a degree that much of the fuel which has been supplied to the open portion is not received through the receiving opening to the supply passage, but supplied into the pilot combustion channel, whereas a small amount of the fuel passes through the open portion to be received through the receiving opening into the supply passage and eventually fed to the main combustion channel.

However, with the burner apparatus having the above-described fluid control construction, in the low combustion load condition, if the amount of fuel which passes through the slit-like open portion to be received into the supply passage to eventually reach the main combustion channel is too small, the fuel-air mixture supplied from the main combustion channel to the combusting section becomes too thin, so that even if the pilot combustion is a stable flame-stabilizing combustion, it becomes impossible to ignite this excessively thin fuel-air mixture, thus leading to exhaust of unburned component such as CO.

Incidentally, the equivalent ratio represents an amount indicative of concentration aspect of the fuel-air mixture of the fuel and the combustion air and this is defined herein as follows.

equivalent ratio=(fuel concentration/air concentration)/(fuel concentration/air concentration) st

Each concentration is represented in the mole value, and (fuel concentration/air concentration) st is a theoretical fuel-air ratio. This theoretical fuel-air ratio is the concentration ratio between an amount of fuel and air needed for complete oxidation of that amount of fuel.

### DISCLOSURE OF THE INVENTION

Therefore, in view of the above-described state of the art, in the burner apparatus having a fluid control construction, an object of the present invention is to provide a technique which allows restriction of emission of unburned component even when a low-combustion load operation is effected.

According to the characterizing feature of the burner apparatus relating to the present invention, said each combustion channel includes a supplying portion for supplying the fuel; a supplying passage is provided between the respective combustion channels, the supplying passage being configured for receiving a portion of the fuel supplied through the supplying portion to the one fuel combustion channel and then supplying this to the supplying portion of the next-stage combustion channel only when the flow amount of the fuel from the supplying portion is above a predetermined critical flow amount; and combustion load adjusting means is provided for adjusting combustion load through adjustment of a total supply amount of the fuel so that the flow amount of the fuel from the supplying portion may be contained within a range encompassing said predetermined critical flow amount.

That is to say, the burner apparatus having the above-described characterizing construction includes a plurality of combustion channels comprising the pilot combustion channel, the main combustion channel, and so on.

And, in this burner apparatus, in each of the plurality of combustion channels comprising the pilot combustion channel, the main combustion channel, and so on, there is provided a supplying portion for supplying the fuel. And, between the respective combustion channels, there is provided a supplying passage capable of receiving a portion of the fuel supplied through the supplying portion to the one fuel combustion channel comprising e.g. the pilot combustion channel and then supplying this to the supplying portion of the next-stage combustion channel comprising e.g. the main combustion channel.

Therefore, in the former-stage combustion channel, between the supplying portion and the receiving portion for receiving the fuel from the supplying passage, there is formed an open portion open to this combustion channel or a passage, with the entire passage or a portion thereof being covered with a porous plate or the like and being partially open to the combustion channel.

And, this supplying portion and the receiving portion of the supplying passage provide a fluid control construction for effecting the above-described fuel distributing ratio adjustment by utilizing the flow of the air (an example of “oxygen-containing gas”) running at the former-stage open portion. With this fluid control construction, there can be realized a burner apparatus which allows the adjustment of the distribution ratio of the fuel to the main combustion channel and the pilot combustion channel based on the combustion load or the like to be effected easily and which also allows increase in the distribution ratio of the supply amount to the combustion channel such as the pilot combustion channel relative to the next-stage combustion channel such as the main combustion channel, in association with reduction in the total supply amount of the fuel.

Further, with the fluid control construction of the burner apparatus having the characterizing construction, the shapes, positional relationship of the supplying portion and the receiving portion of the supplying passage and the flow speed of the air therebetween are set, so that when the flow mount of the fuel supplied from the supplying portion to the combustion channel having the receiving portion of the supplying passage is below the predetermined critical flow amount, all the supplied fuel will be carried away by the air flow of this combustion channel, then being unable to reach the supplying passage and, on the other hand, that only when the flow amount of the fuel supplied from the supplying portion exceeds the predetermined critical flow amount, a portion of the supplied fuel will be received into the supplying passage to be fed eventually to the next-stage combustion channel.

Incidentally, the “predetermined critical flow amount” is intended to refer to such flow amount that even when this critical flow amount of fuel is supplied to the combustion channel having the fluid control construction which is constructed as e.g. the pilot combustion channel, the fuel-air mixture formed in this combustion channel will not have an equivalent ratio exceeding the upper flammable limit.

And, by adjustment of the combustion load through adjustment of the total supply amount of the fuel so that the flow amount of the fuel supplied from the supplying portion to the combustion channel having the receiving portion of the supply passage, the combustion load adjusting means for effecting the combustion load adjustment through adjustment of the total supply amount of the fuel can effect the low combustion load operation by supplying the fuel only to some combustion channels for effecting the pilot combustion. And, in the low combustion load operation, since excessively thin fuel-air mixture is not formed in the next-stage combustion channel such as the main combustion channel, generation of unburned component may be restricted.

On the other hand, with the combustion load adjusting means of this characterizing construction, by setting the total supply amount of the fuel such that the flow amount of the fuel supplied from the supplying portion to the combustion channel having the receiving portion of the supply passage exceeds the predetermined critical flow amount, the fuel is supplied also to the next-stage combustion channel, whereby the high combustion load operation can be effected with both the main combustion and the pilot combustion. Further, in this high combustion load operation, the greater the flow amount of the fuel from the supplying portion to the combustion channel having the receiving portion of the supply passage, the greater the ratio of the fuel to be received into the supply passage. As a result, the distribution ratio of the fuel to the next-stage combustion channel such as the main. combustion channel can be increased in association with increase in the total supply amount of the fuel. Conversely, the distribution ratio of the fuel to the next-stage combustion channel can be decreased in association with decrease in the supply amount of the fuel.

Therefore, in response to increase in the flow amount of the fuel, in other words, in response to increase in the combustion load, the distribution ratio of the fuel to the next-stage combustion channel can be increased. As a result, in the high combustion load operation, when the combustion load is relatively low, the pilot combustion may be stable. Whereas, in the high combustion load operation, when the combustion load is relatively high, the fuel can be supplied evenly to all the respective combustion channels, so that low NOx combustion operation with thin pre-fuel-air mixture is made possible.

Thus, with this characterizing construction, with such simple construction, there can be realized a burner apparatus which can effectively restrict emission of unburned components at the time of low combustion load operation and which also can achieve high efficiency as well as low NOx emission over a wide combustion load range.

Incidentally, the burner apparatus of the invention may include more than three combustion channels and the above-described supply passage may be provided between the respective combustion channels, thereby forming a plurality of the fluid control constructions.

Further, according to the further characterizing feature of the burner apparatus relating to the present invention, in addition to the above-described characterizing feature, between a supply opening acting as said supplying portion and a receiving opening for receiving the fuel of the supply passage, there is formed an open portion open to the combustion channel, and a supplying direction of the fuel from the supplying portion to the open portion traverses a flow direction of the oxygen-containing gas at the open portion.

That is, in the burner apparatus having this characterizing feature, in the combustion channel, said supply opening and said receiving opening are disposed and open in opposition to each other and spaced apart by a predetermined distance in the direction traversing this combustion channel. And, between these, the open portion which is provided as e.g. a slit-like gap is formed. Further, the fuel is supplied, along the direction traversing the flow direction of the air at the open portion toward the receiving opening, through the supply opening into the open portion exposed to the combustion channel.

And, the fuel which has flown into the open portion will be affected by the flow of the air at the combustion channel traversing this slit-like open portion. And, if. e.g. the flow amount of this fuel is below the critical flow amount, all the fuel having flown into the open portion will be carried away by the air flow to be supplied to the downstream side of this combustion channel, instead of reaching the receiving opening. On the other hand, if the flow amount of the fuel having flown into the open portion exceeds the critical flow amount, a portion of this fuel having flown into the open portion will be supplied to the downstream side of this combustion channel, whereas another portion of the fuel will reach the receiving opening to be subsequently supplied via the supply passage to the next-stage combustion channel.

Further, since the open portion is provided in the form of a slit extending along the flow direction of air, the air can be passed to the open portion in a stable manner, so that this air can stably affect the fuel passing this open portion. As a result, the distribution of the fuel to the respective combustion channel may be effected stably.

Therefore, in the burner apparatus having the fluid control construction, which can supply the fuel to the respective combustion channels including the pilot combustion channel and the main combustion channel with the distribution ratio adjustment uniquely applied thereto, thereby to achieve restriction of emission of unburned component at the time of the low combustion load operation as well as the high efficiency and low NOx emission over a wide combustion load range, the main combustion and the pilot combustion at the time of the high combustion load operation can proceed stably.

Further, according to a still further characterizing feature of the burner apparatus relating to the present invention, in addition to the above-described characterizing feature, the supply direction of the fuel from the supplying portion to the open portion is a direction toward the upstream side of the flow direction of the oxygen-containing gas of the combustion channel.

Namely, in the burner apparatus relating to the present invention having the supplying portion and the receiving portion of the supply passage constructed as the fluid control construction, with this characterizing feature wherein the supply direction of the fuel from the supplying portion to the open portion is set as a direction inclined toward the upstream side of the direction of the air flow relative to the direction normal to the flow direction of the air flowing in this open portion, in order for the fuel having flown from the supplying portion into the open portion to be received by the receiving portion of the supply passage, the flow amount of the fuel flowing from the supplying portion needs to be such a flow amount that the fuel can pass the open portion against the flow direction of the air.

Then, the predetermined critical flow amount which is the threshold value for the high combustion load operation for the flow amount of the fuel supplied from the supplying portion to the open portion in the low combustion load operation can be set to be relatively high. And, at the time of the low combustion load operation, introduction of the fuel supplied to the combustion channel toward the receiving opening can be effectively prevented, thereby to effectively restrict generation of unburned components due to the supply of small amount of fuel to the subsequent-stage combustion channel.

Further, according to a still further characterizing feature of the burner apparatus relating to the present invention, in addition to the above-described characterizing feature, said supplying portion of at least one supply passage comprises a supply opening which is open toward the upstream side of the flow direction of the oxygen-containing gas of the combustion channel.

With this characterizing feature, the supplying portion for supplying the fuel received in the supply passage to the next-stage combustion channel comprises an supply opening which is open toward the upstream side of the flow direction of the air, relative to the direction normal to the flow direction of the air in this combustion channel. With this, the fuel from this supply opening will flow against the flow direction of the air. Therefore, in the next-stage combustion channel, the fuel and the air will collide against each other to be mixed and stirred naturally, so that the fuel may be dispersed along the direction of the cross section of the channel.

In this way, according to the burner apparatus having the above characterizing feature, with the above-described construction of the supply opening of e.g. the main combustion channel, it is not necessary to provide a number of supply openings of a small diameter in order to achieve uniform supply of the fuel. Instead, the aperture area of the supply opening of the supply passage may be enlarged advantageously. Hence, there will occur no significant pressure loss in the course of the supply of fuel in the supply passage and the mixing degree of the fuel-air mixture in the next-stage combustion channel may be increased by utilizing the collision between air and fuel.

And, in combination with the burner apparatus having the fluid control construction comprising the supplying portion, the receiving portion of the supply passage and son on, in the supply passage, an appropriate pressure may be applied in the direction from the supply opening to the receiving portion by means of the flow of the air opposing to the supply opening. With such pressure applied from the supply opening to the receiving side, in the low combustion load operation, the predetermined critical flow amount, which is the threshold value for the high combustion load operation, for the flow amount of the fuel supplied from the supplying portion of the former-stage combustion channel to the receiving portion, may be set to be relatively high. Hence, at the time of the low combustion load operation, introduction of the fuel supplied to the former-stage combustion channel toward the receiving opening can be effectively prevented, thereby to effectively restrict generation of unburned components due to the supply of small amount of fuel to the subsequent-stage combustion channel.

On the other hand, at the time of the high combustion load operation, the flow amount of the fuel supplied from the supplying portion to the former-stage combustion channel will be adjusted in such a manner that at least a portion of the fuel supplied from the supplying portion to the former-stage combustion channel may be received into the supply passage by overcoming the pressure applied from the supply opening of the supply passage to the receiving portion. Moreover, since the pressure loss at the next-stage supply opening is small, the flow amount of the fuel to be supplied to the next-stage combustion channel may be effectively increased in association with increase in the combustion load. As a result, the low NOx emission effect due to the uniform supply of the fuel may be further improved.

Further, according to a still further characterizing feature of the burner apparatus relating to the present invention, in addition to the above-described characterizing feature, at least a portion of the supply passage is open to an oxygen-gas supplying portion where the oxygen-containing gas is supplied.

Namely, according to this characterizing feature, a portion of the supply passage is open to the oxygen-containing gas supplying portion where the oxygen-containing gas is supplied. With this, air can be introduced into the supply passage so as to achieve an appropriate concentration for the fuel passing in the supply passage, whereby the fuel to be supplied to the next-stage combustion channel may have an appropriately concentration. Thus, the fuel-air mixture of an appropriate equivalent ratio may be formed at each combustion channel, so that in the combusting section, the fuel-air mixture of the appropriate equivalent ratio may be combusted for restricting generation of NOx and unburned components.

Further, according to a still further characterizing feature of the burner apparatus relating to the present invention, in addition to the above-described characterizing feature, a discharge opening of the supply passage for discharging the fuel to the oxygen-containing gas supplying portion is open in the direction toward the upstream side in the flow direction of the oxygen-containing gas at the oxygen-containing gas supplying portion.

Namely, in the burner apparatus relating to the present invention in which a portion of the supply passage is open to the oxygen-containing gas supplying portion where the oxygen-containing gas is supplied, with the above feature, the oxygen-containing gas supplying portion includes the discharge opening communicated with the receiving portion of the supply passage and this discharge opening is open in the direction inclined toward the upstream side in the flow direction of the air, relative to the direction normal to the flow direction of the air. With this, to the receiving portion located on the upstream side of the discharge opening of the supply passage, there is applied a slight resistance against the fuel flow due to the pressure applied to the discharge opening by the flow of the air in the oxygen-containing gas supplying portion.

Therefore, in the low combustion load operation, the predetermined critical flow amount, which is the threshold value for the high combustion load operation, for the flow amount of the fuel supplied from the supplying portion of the former-stage combustion channel to the receiving portion, can be set to be relatively high. Accordingly, at the time of the low combustion load operation, introduction of the fuel supplied to the former-stage combustion channel to the receiving portion of the supply passage can be appropriately checked, so that generation of unburned components due to the supply of small amount of fuel to the next-stage combustion channel may be effectively avoided.

According to a characterizing feature of a gas turbine engine relating to the present invention, the gas turbine engine includes the burner apparatus having any one of the above-described characterizing features and a turbine of the engine is rotatably drive by kinetic energy of combustion exhaust gas exhausted from the burner apparatus.

Namely, the above-described burner apparatus of the present invention which achieves low NOx generation and high efficiency over a wide combustion load range can be used by itself as a burner apparatus for an incinerator for example. However, this apparatus is particularly useful as a burner apparatus for a gas turbine engine. Such gas turbine engine can operate over a wide operational load range while maintaining low NOx reduction and high efficiency.

### BRIEF DESCRIPTION OF THE DRAWINGS

FIG. 1 is a side view in vertical section showing an embodiment of a burner apparatus of the present invention,

FIG. 2 is a front view in horizontal section of the burner apparatus shown in FIG. 1,

FIG. 3 is an enlarged view of a fuel supplying means of the burner apparatus shown in FIG. 1,

FIG. 4 is a graphic diagram showing relationship between fuel gas supply amounts and supply conditions of the burner apparatus shown in FIG. 1,

FIG. 5 is an enlarged view of a fuel supplying means of a burner apparatus according to a further embodiment,

FIG. 6 is an enlarged view of a fuel supplying means of a burner apparatus according to a further embodiment,

FIG. 7 is a view showing a channel layout of a burner apparatus according to a further embodiment, and

FIG. 8 is a view showing a schematic construction of the fuel supplying means of the burner apparatus shown in FIG. 7.

### BEST MODE OF EMBODYING THE INVENTION

Embodiments of a burner apparatus relating to the present invention will be described next.

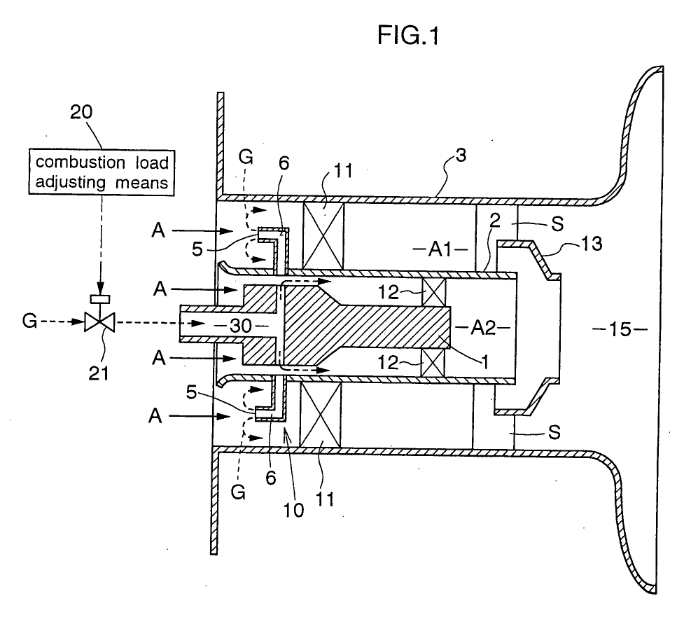

A burner apparatus shown in FIG. 1 is for use in a gas turbine engine in particular. The apparatus includes a gas tube 1 defining a fuel channel 30 for receiving fuel gas G (an example of “fuel”) which is city gas via a flow-amount adjusting valve 21, an inner tube 2 defining a second channel A2 as a pilot combustion channel surrounding the gas tube 1, an outer tube 3 defining a first channel A1 as a main combustion channel surrounding the inner tube 2, an air supplying means for supplying air A (an example of “oxygen-containing gas”) to the first channel A1 and the second channel A2, and a fuel supplying means 10 for supplying the fuel of a fuel channel 30 to the first channel A1 and the second channel A2. In operation, the fuel gas G and the combustion air A are supplied to the main combustion channel and the pilot combustion channel to be mixed in the channels to provide a fuel-air mixture, which is combusted in a combustion chamber 15 (an example of “combusting section”).

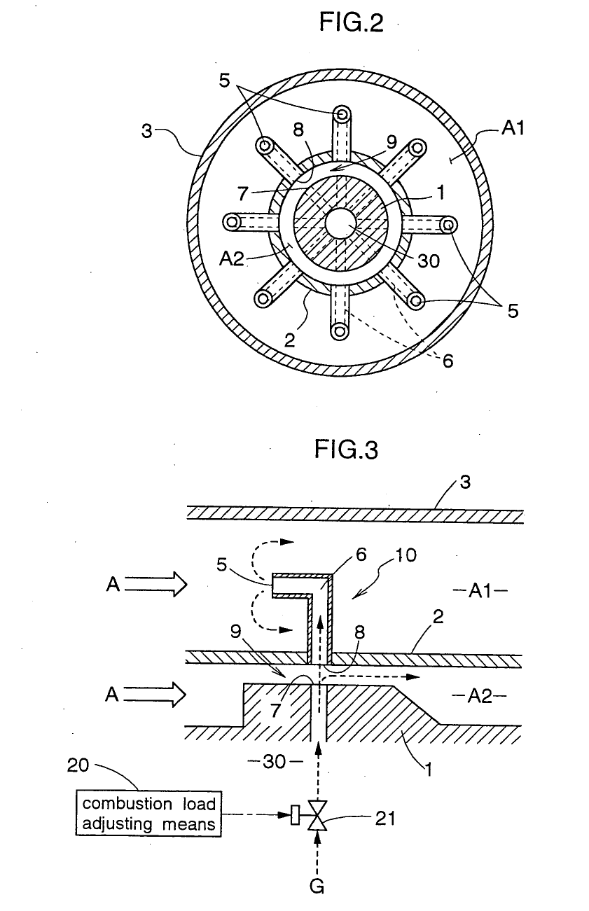

The gas tube 1, the inner tube 2 and the outer tube 3 are disposed coaxially, as shown in FIG. 2 That is, the first channel A1, the second channel A2 and the fuel channel 30 are juxtaposed.

The air supplying means is a means for forcing the air A into the first channel A1 and the second channel A2 from one end thereof by means of an unillustrated compressor, blower, etc.

The fuel supplying means 10 is a means for supplying the fuel gas G supplied to the fuel channel 30 in distribution to the first channel A1 and to the second channel A2.

That is to say, this fuel supplying means 10, as shown in FIG. 2 and FIG. 3, supplies and distributes the fuel gas G inside this fuel channel 30 to the first channel A1 and to the second channel A2.

More particularly, the fuel supplying means 10 includes a supply opening 7 (an example of “supplying portion”) for supplying the fuel gas G of the fuel channel 30 to an open portion 9 of the second channel A2 which is one combustion channel and a supply passage 6 having at one end thereof a receiving opening 8 for receiving a portion of the fuel gas G supplied to the open portion 9 only when the flow amount of the fuel gas G supplied to the open portion 9 from the supply opening 7 exceeds a predetermined critical flow amount. Further, the other end of the supply passage 6 is formed as a supply opening 5 (an example of the “supplying portion”) which is open to the first channel A1 which is the next-stage combustion channel. Further, a plurality of these supply openings 7 and supply passages 6 are provided at eight positions in distribution along a peripheral direction centering about the axis of the first channel A1 and the second channel A2.

And, the open portion 9 and the supply passage 6 are constructed as a so-called fluid control construction. According to this fluid control construction, when the flow amount of the fuel gas G supplied from the fuel channel 30 via the supply opening 7 into the open portion 9 is below the predetermined critical flow amount, all of the fuel gas G supplied to the open portion 9 is supplied to the second channel A2. Whereas, when the flow amount of the fuel gas G supplied via the supply opening 7 to the open portion 9 exceeds the predetermined critical flow amount, a portion of the fuel gas G supplied to the open portion 9 is received by the supply passage 6 and then supplied via the supply opening 5 into the first channel A1.

Incidentally, the above-described predetermined critical flow amount refers to such a flow amount that even when all of this critical flow amount of the fuel gas G is supplied to the second channel A2, the fuel-gas mixture formed in the second channel A2 will not have a value exceeding a upper flammable limit equivalent ratio.

The open portion 9 characterizing this fluid control construction is formed between the supply opening 7 for receiving the fuel gas G and the receiving opening 8 of the supply passage 6 disposed in opposition to the supply opening 7, and the supply direction of the fuel gas G from the supply opening 7 to the receiving opening 8 is set normal to the flow direction of the air in the second channel A2.

In the open portion 9 of the fluid control construction described above, the fuel gas G is supplied from the supply opening 7 to the slit-like open portion 9 exposed to the second channel A2 in the direction toward the receiving opening 8 side.

And, the fuel gas G having flown into the open portion 9 of the second channel A2 will be affected by the flow of the air A of the second channel A2 passing through the open portion 9. Therefore, when the flow amount (the flow amount referred to herein is in proportion to the velocity, since the aperture area of the supply opening 7 is fixed) is below the critical flow amount, all of the fuel gas G flown into the open portion 9 will not reach the receiving opening 8, rather, will be carried away by the flow of the air A to be supplied to the downstream side of the second channel A2. On the other hand, when the flow amount of the fuel gas G flown into the open portion 9 exceeds the critical flow amount, a portion of this fuel gas G having flown into the open portion 9 will be supplied to the downstream side of the second channel A2, while a further portion of the fuel gas g will reach the receiving opening 8 and then will be supplied via the supply opening 5 into the first channel A1.

Further, the burner apparatus includes also a combustion load adjusting means 20 for effecting adjustment of combustion load at the combusting section 15 through adjustment of the total supply amount of the fuel gas G to the supply channel 30 by means of the flow-amount adjusting valve 21.

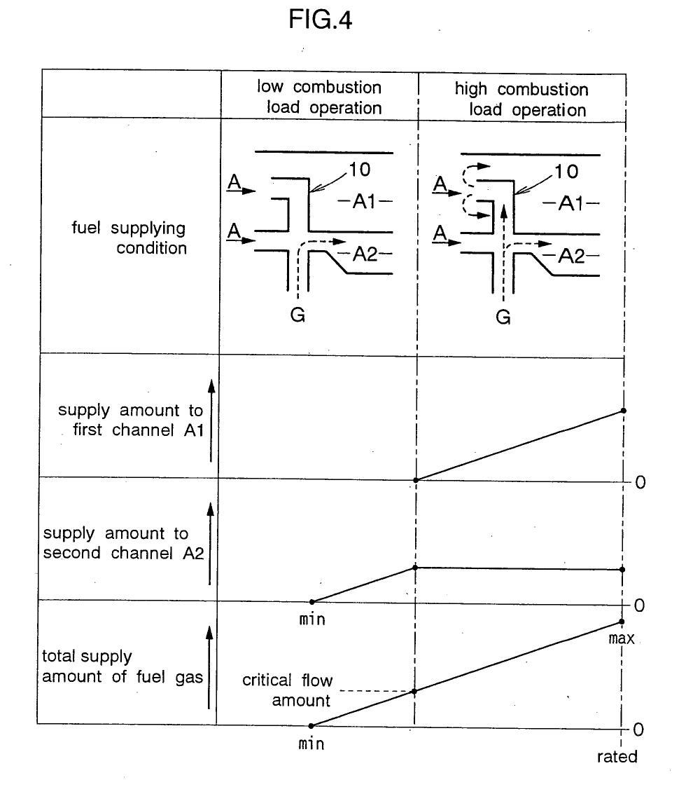

And, for effecting a low combustion load operation, this combustion load adjusting means 20, as shown in FIG. 4, sets the total supply amount of the fuel gas G so that the flow amount of the fuel gas G supplied from the supply opening 7 to the open portion 9 may be below the predetermined critical flow amount, whereby a pilot combustion alone is effected in the combusting chamber 15. On the other hand, for effecting a high combustion load operation, this combustion load adjusting means 20 sets the total supply amount of the fuel gas G supplied from the supply opening 7 to the open portion 9 may exceed said predetermined critical flow amount, whereby the combustion gas G is supplied to both the second channel A2 and the first channel A1, so that both the main combustion and the pilot combustion are effected in the combustion chamber 15.

With the provision of the fuel supplying means 10 having the above-described fluid control construction, in the low combustion load operation, no excessively thin fuel-air mixture will be formed in the first channel A1, so that generation of unburned components may be restricted. Further, with the provision of the fuel supplying means 10 having the fluid control construction, in the high combustion load operation, as the flow amount of the fuel gas G flowing through the supply opening 7 into the open portion 9 increases; in other words, as the combustion load approaches the rated combustion load, the ratio of the fuel gas G supplied through the open portion 9 to the supply opening 5, that is, to the first channel A1 side increases. As a result, in association with increase in the total supply amount of the fuel gas G, the distribution ratio of the fuel gas G to the first channel A1 side for the main combustion can be increased. Accordingly, in association with increase in the total supply amount of the fuel gas G, in other words, with increase in the combustion load, the distribution ratio of the fuel to the first channel A relative to the second channel A2 can be increased. And, in the high combustion load operation, when the combustion load is relatively low, the pilot combustion may take place stably. Whereas, in the high combustion load operation, when the combustion load is relatively high, and near the rated load, the fuel gas G may be supplied evenly to the entire first channel A1 and second channel A2, whereby low NOx combustion by thin pre-mixed fuel-air mixture is made possible.

Further, as the supplying direction of the fuel gas G from the supply opening 7 to the open portion 9 is inclined toward the upstream side relative to the flow direction of the air A at the open portion 9, it becomes possible to make it difficult for the fuel gas G to enter the receiving opening 8. So that, by setting the critical flow amount to a relatively high value, the low combustion load operation and the high combustion load operation may be switched over.

Further, with the burner apparatus of this embodiment, the supplying direction of the fuel gas G from the supply opening 5 to the first channel A1 is the opposite direction to the flow direction of the air A in the first channel A1 and further the supply opening 5 is disposed substantially at the center in the radial direction toward the axis of the first channel.

Therefore, in the high combustion load operation, the fuel gas G supplied from the supply opening 5 into the first channel A1 in opposition to the flow of the air A is caused to collide against the air A, so that the gas may be distributed in the radial direction as well as in the peripheral direction of the first channel A1.

Moreover, since the supply opening 5 is formed with such a posture as to supply the fuel gas G in the direction toward the upstream side of the flow direction of the air A in the first channel A1 the flow of the air A opposing to the supply opening 5 can apply an appropriate amount of pressure from the supply opening 5 of the supply passage 6 toward the receiving opening 8, thereby to apply an appropriate amount of resistance to the fuel gas G entering the receiving opening 8 from the open portion 9. Accordingly, in the low combustion load operation, the predetermined critical flow amount at which the operation is switched over to the high combustion load operation, may be set to a relatively high value. In this way, as the appropriate amount of resistance is applied to the fuel gas G flowing into the receiving opening 8 from the open portion 9, in the low combustion load operation, it is possible to effectively prevent the fuel gas G having flown into the open portion 9 from entering the receiving opening 8, thereby to effectively prevent generation of unburned components.

In the first channel A1 and at a portion thereof more downstream than the fuel supplying means 10, there is disposed a first swirler 11 for applying a swirling force to the fuel-air mixture of the air A and the fuel gas G.

Further, in the second channel A2 and at an intermediate portion thereof in the flow direction, there is disposed a second swirler 12 for applying a swirling force to the fuel-air mixture of the air A and the fuel gas G which has flown into this second channel A2.

With these swirlers 11, 12, the flame stabilization of the main combustion by the flame of the pilot combustion may be improved. That is, as the fuel-air mixture is ignited by an unillustrated ignition device simultaneously with the application of the swirling force thereto by the second swirler 12, this fuel-air mixture is ignited and combusted for pilot combustion. And, as the flame of this pilot combustion is transferred to the fuel-air mixture which has flown through the first channel A1, this fuel-air mixture is ignited for causing the main combustion.

Further, adjacent the downstream end of the inner tube 2, there is provided an air-stage ring 13 for combining and mixing a portion of the fuel-air mixture which has flown in the first channel A1 with the fuel-air mixture which has flown in the second channel A2.

In the figure, mark S denotes struts which are disposed in distribution along the peripheral direction to support the inner tube 2 to the outer tube 3.

Next, a further embodiment of the burner apparatus of the present invention will be described with reference to the drawings.

In the case of the burner apparatus according to the foregoing embodiment, the combustion channels for receiving the fuel gas G into the air A flowing therein and then feeding the resultant fuel-air mixture to the combustion chamber 15 comprises the two combustion channels of the second channel A2 and the first channel A1. However, in the case of a further burner apparatus including more than three combustion channels too, the fuel supplying means of the fluid control construction characterizing the present invention may be provided. Such alterative fuel supplying means 10 will be described in details next.

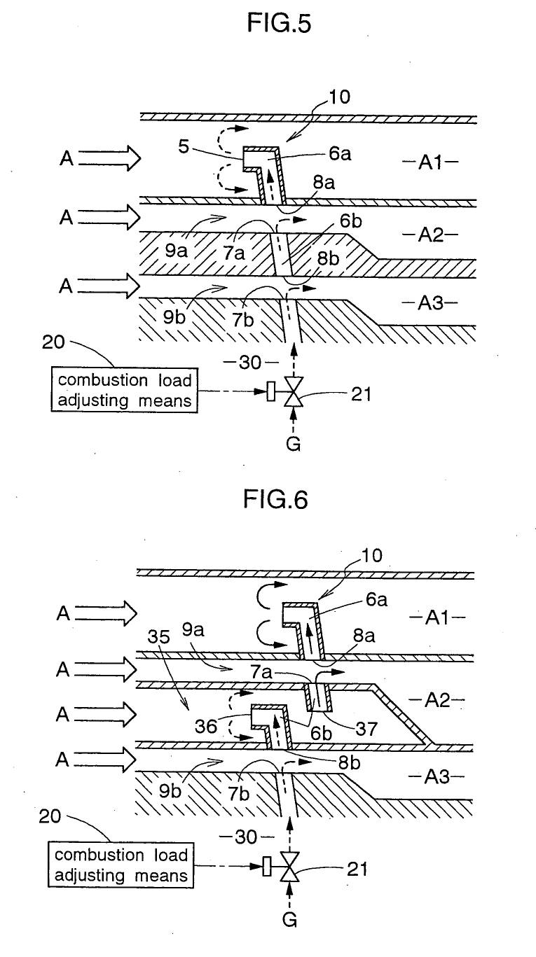

The fuel supplying means 10 of the burner apparatus shown in FIG. 5 is configured to supply in distribution the fuel to the three combustion channels of the first channel A1, second channel A2 and the third channel A3.

More particularly, in this fuel supplying means 10, two supply passages 6a, 6b are disposed between the third channel A3 and the second channel A2 and between the second channel A2 and the first channel A1, respectively. And, the terminal end of the supply passage 6a is formed as a supply opening 5 open to the first channel A1.

That is, the third channel A3 includes a supply opening 7b for supplying the fuel gas G from the fuel channel 30 to the open portion 9b of the third channel A3 and a receiving opening 8b of the supply passage 6b for receiving a portion of the fuel gas G supplied to the open portion 9b only when the flow amount of the fuel gas G supplied through the supply opening 7b to the open portion 9b exceeds the predetermined critical flow amount. Similarly, the second channel A2 includes a supply opening 7a for supplying the fuel gas G from the fuel channel 30 to the open portion 9b of the third channel A3 and a receiving opening 8b of the supply passage 6a for receiving a portion of the fuel gas G supplied to the open portion 9b only when the flow amount of the fuel gas G supplied through the supply opening 7a to the open portion 9a exceeds the predetermined critical flow amount. The fuel supplying means 10 having the above-described construction includes a plurality of fluid control constructions each including the respective open portions 9a, 9b and the respective supply passages 6a, 6b, with the control constructions being arranged in series.

And, when the combustion load adjusting means 20 adjusts, by the flow-amount adjusting valve 21, the total supply amount of the fuel gas G such that the flow amount of the fuel gas G supplied through the supply opening 7b into the open portion 9b is below the predetermined critical flow amount, thereby to effect a first low combustion load operation, all of the fuel gas G supplied through the supply opening 7b into the open portion 9b is supplied to the third channel A3. Also, when the combustion load adjusting means 20 adjusts the total supply amount of the fuel gas G so that the flow amount of the fuel gas G supplied through the supply opening 7b into the open portion 9b exceeds a predetermined first critical flow amount and also that the flow amount of the fuel gas G received into the supply passage 9b and then supplied via the supply opening 7a into the open portion 9a is blow the predetermined critical flow amount, thereby to effect a second low combustion load operation, a portion of the fuel gas supplied into the open portion 9b will enter the receiving opening 8b to be received into the supply passage 6b and all of the fuel gas G received into the supply passage 6b will be supplied to the second channel A2. Further, when the total supply amount of the fuel gas G is adjusted so that the flow amount of the fuel gas G received by the supply passage 6b and then supplied via the supply opening 7a into the open portion 9a exceeds the predetermined critical flow amount, a portion of the fuel gas G supplied to the open portion 9a will enter the receiving opening 8a and then be received into the supply passage 6a and this fuel gas G received into the supply passage 6a will be supplied via the supply opening 5 into the first channel A1.

With the fuel supplying means 10 having the above-described construction, in the first low combustion load operation, no excessively thin fuel-air mixture is formed in the first channel A1 and the second channel A2,so that generation of unburned components can be restricted. Further, in the second low combustion load operation, no excessively thin fuel-air mixture is formed in the second channel A2, so that generation of unburned components can be restricted. In addition, by increasing the ratio of the fuel gas G supplied to the second channel A2 side in association with increase in the flow amount of the fuel gas G, the fuel gas G can be supplied uniformly to the second channel A2 and the third channel A3, so that low NOx operation is made possible. Moreover, in the high combustion load operation, as the flow amount of the fuel gas G increases, in other words, as the combustion load approaches the rated combustion load, the ratio of the fuel gas G passing the open portions 9a, 8b to be supplied to the supply opening 5 side, i.e. to the first channel A1 side is increased.

As a result, the distribution ratio of the fuel gas G to the first channel A1 side for the main combustion can be increased in association with increase in the total supply amount of the fuel gas G. And, in association with increase in the total supply amount of the fuel gas G, that is, with increase in the combustion load, the distribution ration of the fuel to the first channel A1 relative to the second channel A2 can be increased. Hence, in the high combustion load operation, when the combustion load is relatively low, the pilot combustion at the second channel A2 and the third channel A2 may proceed stably. Whereas, when the combustion load is relatively high and near the rated combustion load, the fuel gas G can be supplied uniformly over the entire first channel A2, second channel A2 and third channel A3, so that low NOx combustion by thin pre-mixed fuel-air mixture is made possible.

Further, with the fuel supplying means 10 of the burner apparatus shown in FIG. 5, the supply passage is disposed with its supply opening 5 side being inclined toward the upstream side of the flow direction of the air A such that the supply openings 7a, 7b may supply the fuel gas G in the direction toward the upstream side of the flow direction of the air A at the open portions 9a, 9b. Therefore, in order for the fuel gas G which has flown into the open portions 9a, 9b from the supply openings7a, 7b to enter the receiving openings 8a, 8b it is necessary to set the flow amount of the fuel gas G flowing out of the supply openings 7a, 7b to such an amount which exceeds a flow amount which passes the open portions 9a, 8b against the flow direction of the air A at the open portions 9a, 9b. Hence, the predetermined first and second critical flow amounts can be set relatively high. Therefore, in the first or second low combustion load operation, it is possible to effectively prevent the fuel gas G supplied to the open portion 9a or 9b from flowing into the receiving opening 9a or receiving opening 9b.

Further, the burner apparatus of the invention, as shown in FIG. 6, can include an air supplying portion 35 (an example of “oxygen-containing gas supplying portion”). The construction thereof will be described next.

Like the fuel supplying mechanism 10 of the burner apparatus shown in FIG. 5, the fuel supplying means 10 of the burner apparatus shown in FIG. 6 is configured to supply/distribute the fuel to the three combustion channels of the first channel A, second channel A2 and the third channel A3. And, like the fuel supplying means 10 of the burner apparatus shown in FIG. 5, two open portions 9a, 8b and supply passages 6a, 6b constitute the fluid control construction.

Further, with the fuel supplying means 10 of this burner apparatus, the air supplying portion 35 is disposed between the receiving opening 8a of the supply passage 6b and the supply opening 7a. Like the first through third channels A1, A2 and A3, to the air supplying portion 35, the air supplying means supplies the air A and the fuel gas G supplied with the air A flows through the opening 37 to the downstream side. With this fuel supplying portion 35, by introducing the air A into the supply passage 6b so that the fuel gas G flowing in the supply passage 6b may have an appropriate concentration. As a result, it is possible to render appropriate the concentration of the fuel gas G which is supplied from the open portion 9a ad the supply opening 5 located on the downstream side of the flow direction of the fuel gas G relative to the air supplying portion 35 of the supply passage 6b to the second channel A2 and the first channel A1.

Further, the air supplying portion 35 includes a discharge opening 36 which is connected to the upstream side of the flow direction of the fuel gas G of the supply passage 6b and which is formed with such a posture as to supply the fuel gas G toward the upstream side of the flow direction of the air A at the air supplying portion 35.

According to the discharge opening 36 formed with such posture as described above, the fuel gas G supplied from the discharge opening 36 against the flow of the air A at the air supplying portion 35 can be caused to collide against the air A to be dispersed thereby in the supply passage 6b. Further, the flow of the air opposing the discharge opening 36 applies an appropriate amount of pressure in the direction from the discharge opening 36 of the supply passage 6b to the open portion 9b, so that appropriate resistance can be applied to the fuel gas G entering the receiving opening 8b from the open portion 9b. Therefore, the predetermined critical flow amount in the first low combustion load operation which is the threshold value at which the operation is switched over to the second low combustion load operation may be set relatively high. In this way, by applying an appropriate amount of resistance to the fuel gas G flowing from the open portion 9b into the receiving opening 8b, in the first low combustion load operation, it is possible to effectively prevent the fuel gas G having flown into the open portion 9b from entering the receiving opening 8b side. As a result, generation of unburned components can be effectively avoided.

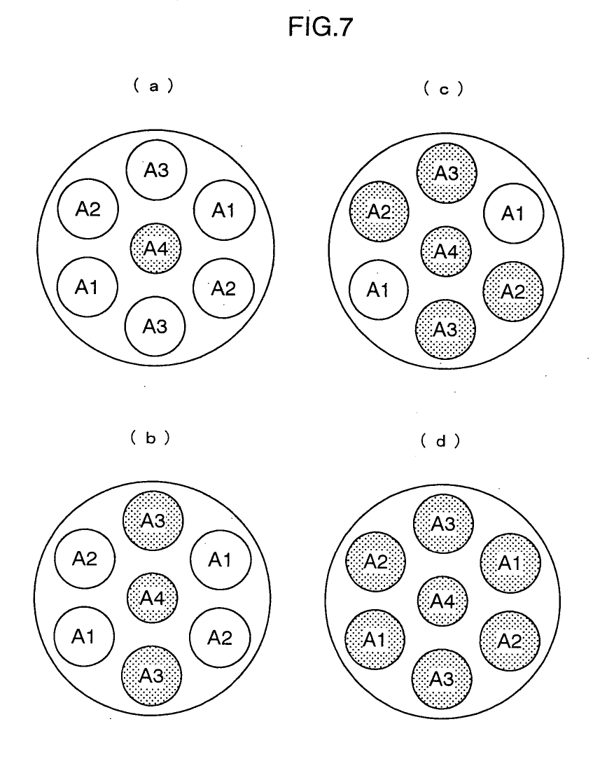

Further, another example of the burner apparatus having more than three combustion channels as described above is a so-called multiple burner including a fourth channel A4 as a pilot combustion channel and first through third channels A1, A2, A3 as a plurality of main combustion channels equidistantly spaced apart from each other along the peripheral direction of the fourth channel, as shown in FIG. 7 (a).

With such burner apparatus, under an operation condition of the lowest combustion load, the fuel gas G is supplied only to the fourth channel A4, so that only this fourth channel A4 is set into the combustion condition as shown in FIG. 7 (a). Incidentally, in FIG. 7, the illustrated combustion channels denoted and filled with dots are under the combustion condition.

And, with such burner apparatus, for increasing the combustion load from the above operation condition, the number of the combustion channels to which the fuel gas G is supplied is increased gradually, so that the apparatus will be set to a condition of FIG. 7 (b) in which in addition to the fourth channel A4, a pair of third channels A3 disposed in point symmetry relative to each other are set into the combustion condition, a further condition of FIG. 7 (c) in which in addition to the fourth channel A4 and the third channel A3, the pair of second channels A2 disposed in the point symmetry relative to each other are set into the combustion condition and to a still further condition of FIG. 7 (d) in which in addition to the fourth channel A4, the third channel A3 and the second channels A2, the pair of first channels A1 disposed in the point symmetry relative to each other are set into the combustion condition for providing the rated operation, one after another.

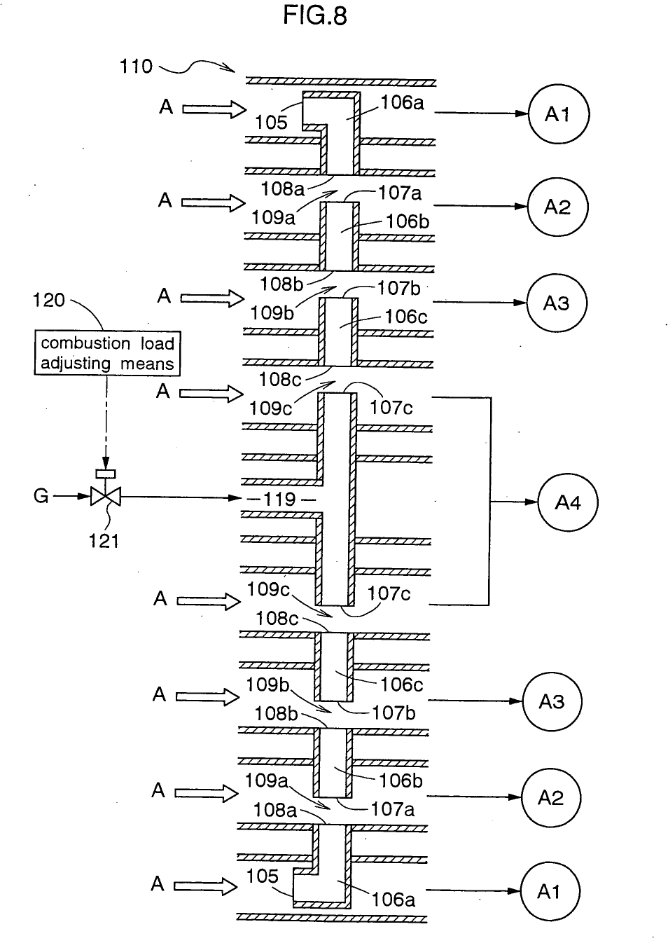

Further, such burner apparatus can be realized with fuel supplying means 110 having a fluid control construction. The construction thereof will be described next with reference to FIG. 8.

That is, the fuel supplying means 110 shown in FIG. 8 is configured to supply and distribute the fuel gas G of the fuel channel 119 to the upstream sides of the respective channels A1, A2, A3, A4.

Further, the fluid control construction of this fuel supplying means 110 is provided respectively between the adjacent channels in FIG. 8, so as to distribute a portion of the fuel gas G supplied to one channel to a next-stage channel.

More particularly, the fuel as G of a fuel channel 119 is divided into two portions to be supplied to the upstream side of the fourth channel A4 via two supply openings 107c (an example of “supplying portion”). In this, the reason why the fuel channel 119 is divided into two lines is that each pair of the total six channels A1, A2 and A3 to which the fuel gas G is supplied in distribution comprise two channels disposed in point symmetry relative to each other and the fuel gas G is supplied in distribution to each of two groups including each one of them.

Alternately, without dividing the fuel channel 119 into such two lines, the fuel-air mixture formed by the distributed supply of the fuel gas G in the fluid control construction can be supplied and distributed to two channels.

Further, in this fuel supplying means 110, three supply openings 106a, 106b, 106c are provided between the first channel A1 and the second channel A2, between the second channel A2 and the third channel A3 and between the third channel A3 and the fourth channel A4, respectively, and the terminal end of the supply passage 106a is formed as a supply opening 105 which is open to the first channel A1.

Namely, on the upstream side of the fourth channel A4, there are provided a supply opening 107c for supplying the fuel gas G of the fuel channel 119 to an open portion 109c of the fourth channel A4 and a receiving opening 108c of the supply passage 106c for receiving a portion of the fuel gas G supplied into the open portion 109c only when the flow amount of the fuel gas G supplied through the supply opening 107c into the open portion 109c exceeds the predetermined critical flow amount. Similarly, on the upstream side of the third channel A3, there are provided a supply opening 107b for supplying the fuel gas G received in the supply passage 106c to an open portion 109b of the third channel A3 and a receiving opening 108b of the supply passage 106b for receiving a portion of the fuel gas G supplied into the open portion 109b only when the flow amount of the fuel gas G supplied through the supply opening 107b into the open portion 109b exceeds the predetermined critical flow amount. Also similarly, on the upstream side of the second channel A2, there are provided a supply opening 107a, an open portion 109a and a receiving opening 108a of the supply passage 106a for receiving a portion of the fuel gas G.

The fuel supplying means 110 having the above-described construction includes a plurality of fluid control constructions each including the respective open portions 109a, 109b, 109c and the respective supply passages 106a, 106b, 106c with the control constructions being arranged in series.

And, with the fuel supplying means 110 having the above-described construction, when combustion load adjusting means 120 adjusts, by a flow-amount adjusting valve 121, the total supply amount of the fuel gas G such that the flow amount of the fuel gas G supplied through the supply opening 107c into the open portion 109c is below the predetermined first critical flow amount, all of the fuel gas G supplied through the supply opening 107c into the open portion 109c is supplied to the fourth channel A4, so that as shown in FIG. 7 (a), only the fourth channel A4 is set to the combustion condition.

Further, when the total supply amount of the fuel gas G is adjusted to exceed the first critical flow amount and also to be below the second critical flow amount, a portion of the fuel gas G supplied to the open portion 109c enters the receiving opening 108c to be received into the supply passage 106c and all of this fuel gas G received into the supply passage 106c is supplied via the supply opening 107b to the third channel A3, so that as shown in FIG. 7 (b) only the fourth channel A4 and the third channel A3 are set to the combustion condition respectively.

Still further, when the total supply amount of the fuel gas G is adjusted to exceed the second critical flow amount and also to be below the third critical flow amount, a portion of the fuel gas G supplied to the open portion 109b enters the receiving opening 108b to be received into the supply passage 106b and all of this fuel gas G received into the supply passage 106b is supplied via the supply opening 107a to the second channel A2, so that as shown in FIG. 7 (c) only the fourth channel A4, the third channel A3 and the second channel A2 are set to the combustion condition respectively. Still further, when the total supply amount of the fuel gas G is adjusted to exceed the third critical flow amount, a portion of the fuel gas G supplied to the open portion 109a enters the receiving opening 108a to be received into the supply passage 106a and all of this fuel gas G received into the supply passage 106a is supplied via the supply opening 105 to the first channel A1, so that as shown in FIG. 7 (d), all of the channels are set into the combustion condition.

With the fuel supplying means 110 having the above-described construction, in the low combustion load operation, no excessively thin fuel-air mixture is formed in the channels which are not in the combustion condition, so that generation of unburned components can be effectively restricted. Further, by gradually increasing the number of the channels to be set into the combustion condition in association with increase in the combustion load, the combustion condition can be maintained stable over the entire combustion load range.

In the foregoing embodiments, the plurality of combustion channels as the pilot combustion channel and the main combustion channel are arranged in the radial or peripheral direction. Instead, the layouts of the respective combustion channels maybe appropriately determined, with consideration to the flame stability and low NOx generation. Further, the fluid control construction provided between the respective combustion channels may be designed, with consideration to e.g. the distribution order, distribution ratio relative to increase in the combustion load.

The foregoing embodiments relate to general cases where the oxygen-containing gas for combustion of the fuel gas G comprises the air A. Instead, as the oxygen-containing gas other than air, e.g. oxygen-rich gas having a higher content of oxygen than air can be employed.

1. A burner apparatus including a plurality of combustion channels in which fuel is supplied to oxygen-containing gas communicated therein and the resultant fuel-air mixture is supplied to a combusting section to be combusted therein;
wherein said each combustion channel includes a supplying portion for supplying the fuel;
a supplying passage is provided between the respective combustion channels, the supplying passage being configured for receiving a portion of the fuel supplied through the supplying portion to the one fuel combustion channel and then supplying this to the supplying portion of the next-stage combustion channel only when the flow amount of the fuel from the supplying portion is above a predetermined critical flow amount; and
combustion load adjusting means is provided for adjusting combustion load through adjustment of a total supply amount of the fuel so that the flow amount of the fuel from the supplying portion may be contained within a range encompassing said predetermined critical flow amount.

2. The burner apparatus according to claim 1, wherein between a supply opening acting as said supplying portion and a receiving opening for receiving the fuel of the supply passage, there is formed an open portion open to the combustion channel, and
a supplying direction of the fuel from the supplying portion to the open portion traverses a flow direction of the oxygen-containing gas at the open portion.

3. The burner apparatus according to claim 2, wherein the supply direction of the fuel from the supplying portion to the open portion is a direction toward the upstream side of the flow direction of the oxygen-containing gas of the combustion channel.

4. The burner apparatus according to claim 1, wherein said supplying portion of at least one supply passage comprises a supply opening which is open toward the upstream side of the flow direction of the oxygen-containing gas of the combustion channel.

5. The burner apparatus according to claim 4, wherein between a supply opening acting as said supplying portion and a receiving opening for receiving the fuel of the supply passage, there is formed an open portion open to the combustion channel, and
a supplying direction of the fuel from the supplying portion to the open portion traverses a flow direction of the oxygen-containing gas at the open portion.

6. The burner apparatus according to claim 5, wherein a portion of the supply passage is open to an oxygen-gas supplying portion where the oxygen-containing gas is supplied.

7. The burner apparatus according to claim 6, wherein a discharge opening of the supply passage for discharging the fuel to the oxygen-containing gas supplying portion is open in the direction toward the upstream side in the flow direction of the oxygen-containing gas at the oxygen-containing gas supplying portion.

8. The burner apparatus according to claim 5, wherein the supply direction of the fuel from the supplying portion to the open portion is a direction toward the upstream side of the flow direction of the oxygen-containing gas of the combustion channel.

9. The burner apparatus according to claim 8, wherein a portion of the supply passage is open to an oxygen-gas supplying portion where the oxygen-containing gas is supplied.

10. The burner apparatus according to claim 9, wherein a discharge opening of the supply passage for discharging the fuel to the oxygen-containing gas supplying portion is open in the direction toward the upstream side in the flow direction of the oxygen-containing gas at the oxygen-containing gas supplying portion.

11. The burner apparatus according to claim 1, wherein a portion of the supply passage is open to an oxygen-gas supplying portion where the oxygen-containing gas is supplied.

12. The burner apparatus according to claim 11, wherein a discharge opening of the supply passage for discharging the fuel to the oxygen-containing gas supplying portion is open in the direction toward the upstream side in the flow direction of the oxygen-containing gas at the oxygen-containing gas supplying portion.

13. The burner apparatus according to claim 11, wherein between a supply opening acting as said supplying portion and a receiving opening for receiving the fuel of the supply passage, there is formed an open portion open to the combustion channel, and
a supplying direction of the fuel from the supplying portion to the open portion traverses a flow direction of the oxygen-containing gas at the open portion.

14. The burner apparatus according to claim 13, wherein a discharge opening of the supply passage for discharging the fuel to the oxygen-containing gas supplying portion is open in the direction toward the upstream side in the flow direction of the oxygen-containing gas at the oxygen-containing gas supplying portion.

15. The burner apparatus according to claim 13, wherein the supply direction of the fuel from the supplying portion to the open portion is a direction toward the upstream side of the flow direction of the oxygen-containing gas of the combustion channel.

16. The burner apparatus according to claim 15, wherein a discharge opening of the supply passage for discharging the fuel to the oxygen-containing gas supplying portion is open in the direction toward the upstream side in the flow direction of the oxygen-containing gas at the oxygen-containing gas supplying portion.

17. The burner apparatus according to claim 11, wherein said supplying portion of at least one supply passage comprises a supply opening which is open toward the upstream side of the flow direction of the oxygen-containing gas of the combustion channel.

18. The burner apparatus according to claim 17, wherein a discharge opening of the supply passage for discharging the fuel to the oxygen-containing gas supplying portion is open in the direction toward the upstream side in the flow direction of the oxygen-containing gas at the oxygen-containing gas supplying portion.

19. A gas turbine engine comprising the burner apparatus according to any one of claims 1-18, wherein a turbine of the engine is rotatably drive by kinetic energy of combustion exhaust gas exhausted from the burner apparatus.
